(19) United States
(12) Patent Application Publication
(10) Pub. No.: US 2026/0281715 A1
(43) Pub. Date: Sep. 17, 2026

(54) SECURITY PROTECTION METHOD AND APPARATUS, COMMUNICATION DEVICE, AND STORAGE MEDIUM

(71) Applicant: Beijing Xiaomi Mobile Software Co., Ltd., Beijing (CN)

(72) Inventor: Wei LU, Beijing (CN)

(73) Assignee: Beijing Xiaomi Mobile Software Co., Ltd., Beijing (CN)

(21) Appl. No.: 18/877,570

(22) PCT Filed: Jun. 20, 2022
(86) PCT No.: PCT/CN2022/099915

§ 371 Date: Dec. 20, 2024

(51) Int. Cl. H04W 12/037; H04W 12/0433

(52) U.S. Cl. CPC H04W 12/037; H04W 12/0433

(57) ABSTRACT

A method, apparatus and computer readable for a security protection based on ranging sidelink positioning protocol. The security protection is performed by: sending ranging sidelink positioning protocol security policy information to a terminal, wherein the ranging sidelink positioning protocol security policy information instructs the terminal to execute a security policy of a ranging sidelink positioning protocol flow (Step 31).

### CROSS-REFERENCE TO RELATED APPLICATIONS

This application is at the national stage of International Application No. PCT/CN2022/099915, filed on Jun. 20, 2022, which is hereby incorporated by reference in its entirety.

### TECHNICAL FIELD

The present disclosure relates to but is not limited to, the technical field of wireless communication, and in particular, to a security protection method and apparatus based on a ranging/sidelink positioning protocol, a communication device, and a storage medium.

### BACKGROUND

In a solution of an enhanced 5G (5 th Generation Mobile Communication Technology) architecture supporting Ranging/Sidelink (SL) positioning, a solution based on a ranging/sidelink positioning protocol is proposed, which is used to transfer Ranging capability, assistance data and/or location information for Ranging/Sidelink Positioning between terminals. In related arts, how the security requirements of Ranging/Sidelink Positioning services could be correctly applied on the ranging/sidelink positioning protocol layer between terminals needs to be studied.

### SUMMARY

Embodiments of the present disclosure provides a security protection method and apparatus based on a ranging/sidelink positioning protocol, a communication device and a storage medium.

A first aspect of the embodiments of the present disclosure provides a security protection method based on a ranging/sidelink positioning protocol, performed by a network function, including:
sending ranging/sidelink positioning protocol security policy information to a terminal; wherein the ranging/sidelink positioning protocol security policy information indicates a security policy for the terminal to perform a ranging/sidelink positioning protocol procedure.

In an embodiment, the ranging/sidelink positioning protocol security policy information indicates a mapping relation between at least one ranging/sidelink positioning service and a corresponding ranging/sidelink positioning protocol security policy.

In an embodiment, the ranging/sidelink positioning protocol security policy information comprises at least one of:
signaling integrity protection information, indicating a following ranging/sidelink positioning protocol policy:
   the terminal only accepts a connection in a case that a PC5 interface is under integrity protection;
signaling confidentiality protection information, indicating one of following ranging/sidelink positioning protocol policies:
   the terminal only accepts a connection in a case that a PC5 interface is under confidentiality protection;
   the terminal only establishes a connection without confidentiality protection;
   the terminal tries to establish confidentiality protection and accepts a connection without confidentiality protection.

In an embodiment, the network function is a policy control function (PCF), and sending the ranging/sidelink positioning protocol security policy information to the terminal comprises: sending the ranging/sidelink positioning protocol security policy information to the terminal during a service authorization and configuration procedure.

In an embodiment, the network function is a 5G proximity service key management function (PKMF) or a 5G proximity service direct discovery name management function (DDNMF), and sending the ranging/sidelink positioning protocol security policy information to the terminal comprises:
sending the ranging/sidelink positioning protocol security policy information to the terminal during a terminal discovery procedure.

A second aspect of the embodiments of the present disclosure provides a security protection method based on a ranging/sidelink positioning protocol, performed by a terminal, including:
receiving ranging/sidelink positioning protocol security policy information sent by a network function;
wherein the ranging/sidelink positioning protocol security policy information indicates a security policy for the terminal to perform a ranging/sidelink positioning protocol procedure.

In an embodiment, the ranging/sidelink positioning protocol security policy information indicates a mapping relation between at least one ranging/sidelink positioning service and a corresponding ranging/sidelink positioning protocol security policy.

In an embodiment, the ranging/sidelink positioning protocol security policy information comprises at least one of:
signaling integrity protection information, indicating a following ranging/sidelink positioning protocol policy:
   the terminal only accepts a connection in a case that a PC5 interface is under integrity protection;
signaling confidentiality protection information, indicating one of following ranging/sidelink positioning protocol policies:
   the terminal only accepts a connection in a case that a PC5 interface is under confidentiality protection;
   the terminal only establishes a connection without confidentiality protection;
   the terminal tries to establish confidentiality protection and accepts a connection without confidentiality protection.

In an embodiment, the network function is a policy control function (PCF), and receiving the ranging/sidelink positioning protocol security policy information sent by the network function comprises:
receiving the ranging/sidelink positioning protocol security policy information sent by the network function during a service authorization and configuration procedure.

In an embodiment, the network function is a 5G proximity service key management function (PKMF) or a 5G proximity service direct discovery name management function (DDNMF), and receiving the ranging/sidelink positioning protocol security policy information sent by the network function comprises:
receiving the ranging/sidelink positioning protocol security policy information sent by the network function during a terminal discovery procedure.

In an embodiment, the terminal is a first terminal initiating direct communication; and the method further comprises:
in response to determining that the first terminal discovers a second terminal, determining that the direct communication is established for a ranging/sidelink positioning service rather than for a proximity service (ProSe).

In an embodiment, the method further includes:
choosing a ranging/sidelink positioning protocol security policy of the first terminal to be sent to the second terminal based on the ranging/sidelink positioning protocol security policy information.

In an embodiment, the method further includes:
sending the ranging/sidelink positioning protocol security policy of the first terminal, or security capability information of the first terminal, or both, to the second terminal.

In an embodiment, sending the ranging/sidelink positioning protocol security policy of the first terminal, or the security capability information of the first terminal, or both, to the second terminal comprises:
sending the ranging/sidelink positioning protocol security policy of the first terminal, or the security capability information of the first terminal, or both, to the second terminal through direct communication request message.

In an embodiment, at least one of: the information of the security algorithm, the ranging/sidelink positioning protocol security policy of the first terminal, or the security capability information of the first terminal sent by the second terminal is received.

In an embodiment, at least one of: the information of the security algorithm, the ranging/sidelink positioning protocol security policy of the first terminal, or the security capability information of the first terminal sent by the second terminal is received through a direct security mode command message.

In an embodiment, the terminal is a discovered second terminal for direct communication; and the method further comprises:
receiving a ranging/sidelink positioning protocol security policy of a first terminal, or security capability information of the first terminal, or both, sent by the first terminal initiating the direction communication.

In an embodiment, receiving the ranging/sidelink positioning protocol security policy of the first terminal, or the security capability information of the first terminal, or both, sent by the first terminal initiating the direction communication comprises:
receiving, through a direct communication request message, the ranging/sidelink positioning protocol security policy of the first terminal, or the security capability information of the first terminal, or both, sent by the first terminal.

In an embodiment, the method further includes at least one of:
rejecting the direct communication request message in response to determining that the ranging/sidelink positioning protocol security policy of the first terminal indicates that the terminal only establishes a connection without integrity protection;
rejecting the direct communication request message in response to determining that the ranging/sidelink positioning protocol security policy of the first terminal indicates that the terminal only establishes a connection without confidentiality protection, and a ranging/sidelink positioning protocol security policy of the second terminal indicates that the terminal only accepts a connection in a case that a PC5 interface is under confidentiality protection; or
rejecting the direct communication request message in response to determining that the ranging/sidelink positioning protocol security policy of the first terminal indicates that the terminal only accepts a connection in a case that a PC5 interface is under confidentiality protection, and a ranging/sidelink positioning protocol security policy of the second terminal indicates that the terminal only establishes a connection without confidentiality protection.

In an embodiment, the method further includes:
initiating, by the second terminal, a direct authentication procedure, or a key establishment procedure, or both, with the first terminal.

In an embodiment, the method further includes at least one of:
accepting the direct communication request message in response to determining that both the ranging/sidelink positioning protocol security policy of the first terminal and a ranging/sidelink positioning protocol security policy of the second terminal indicate that the terminal only establishes a connection without confidentiality protection;
accepting the direct communication request message in response to determining that both the ranging/sidelink positioning protocol security policy of the first terminal and the ranging/sidelink positioning protocol security policy of the second terminal indicate that the terminal only accepts a connection in a case that a PC5 interface is under confidentiality protection;
accepting the direct communication request message in response to determining that the ranging/sidelink positioning protocol security policy of the first terminal indicates that the terminal only establishes a connection without confidentiality protection, and the ranging/sidelink positioning protocol security policy of the second terminal indicates that the terminal tries to establish confidentiality protection and accepts a connection without confidentiality protection;
accepting the direct communication request message in response to determining that the ranging/sidelink positioning protocol security policy of the first terminal indicates that the terminal tries to establish confidentiality protection and accepts a connection without confidentiality protection, and the ranging/sidelink positioning protocol security policy of the second terminal indicates that the terminal only establishes a connection without confidentiality protection;
accepting the direct communication request message in response to determining that the ranging/sidelink positioning protocol security policy of the first terminal indicates that the terminal only accepts a connection in a case that a PC5 interface is under confidentiality protection, and the ranging/sidelink positioning protocol security policy of the second terminal indicates that the terminal tries to establish confidentiality protection and accepts a connection without confidentiality protection; or
accepting the direct communication request message in response to determining that the ranging/sidelink positioning protocol security policy of the first terminal indicates that the terminal tries to establish confidentiality protection and accepts a connection without confidentiality protection, and accepting the direct communication request message in response to determining that the ranging/sidelink positioning protocol security policy of the second terminal indicates that the terminal only accepts a connection in a case that a PC5 interface is under confidentiality protection.

In an embodiment, the method further includes:
in response to determining to adopt the ranging/sidelink positioning protocol security policy, determining a security algorithm for integrity protection, or confidentiality protection, or both, based on the security capability information of the first terminal and security capability information of the second terminal.

In an embodiment, the method further includes:
sending at least one of: information of the security algorithm, the ranging/sidelink positioning protocol security policy of the first terminal, or the security capability information of the first terminal to the first terminal.

In an embodiment, sending the information of the security algorithm includes:
sending at least one of: the information of the security algorithm, the ranging/sidelink positioning protocol security policy of the first terminal, or the security capability information of the first terminal to the first terminal through a direct security mode command message.

In an embodiment, the direct security mode command message is integrity protected with the security algorithm chosen for integrity protection.

A third aspect of the embodiments of the present disclosure provides a security protection apparatus based on a ranging/sidelink positioning protocol, including:
a sending module, configured to send ranging/sidelink positioning protocol security policy information to a terminal;
wherein the ranging/sidelink positioning protocol security policy information indicates a security policy for the terminal to perform a ranging/sidelink positioning protocol procedure.

A fourth aspect of the embodiments of the present disclosure provides a security protection apparatus based on a ranging/sidelink positioning protocol, including:
a receiving module, configured to receive ranging/sidelink positioning protocol security policy information sent by a network function;
wherein the ranging/sidelink positioning protocol security policy information indicates a security policy for the terminal to perform a ranging/sidelink positioning protocol procedure.

A fifth aspect of the embodiments of the present disclosure provides a communication device, including:
a processor;
a memory, storing an instruction executable by the processor;
the processor is configured to execute the executable instruction to implement the method according to any embodiment of the present disclosure.

A sixth aspect of the embodiments of the present disclosure provides a computer storage medium, storing a computer-executable program, wherein when the computer-executable program is executed by a processor, the method according to any embodiment of the present disclosure is implemented.

In the embodiments of the present disclosure, the ranging/sidelink positioning protocol security policy information is sent to the terminal by the network function; where the ranging/sidelink positioning protocol security policy information indicates the security policy for the terminal to perform the ranging/sidelink positioning protocol procedure. As the ranging/sidelink positioning protocol security policy information indicates the security policy for the terminal to perform the ranging/sidelink positioning protocol procedure, after receiving the ranging/sidelink positioning protocol security policy information, the terminal may perform the ranging/sidelink positioning protocol procedure based on the security policy indicated by the ranging/sidelink positioning protocol security policy information, and compared with a manner of performing the ranging/sidelink positioning protocol procedure not based on the security policy, security of inter-terminal ranging/sidelink communication is improved.

### BRIEF DESCRIPTION OF DRAWINGS

FIG. 1 is a schematic structural diagram of a wireless communication system according to an example embodiment.

FIG. 2 is a schematic diagram of a protocol layer according to an example embodiment.

FIG. 3 is a schematic flowchart of a security protection method based on a ranging/sidelink positioning protocol according to an example embodiment.

FIG. 4 is a schematic flowchart of a security protection method based on a ranging/sidelink positioning protocol according to an example embodiment.

FIG. 5 is a schematic flowchart of a security protection method based on a ranging/sidelink positioning protocol according to an example embodiment.

FIG. 6 is a schematic flowchart of a security protection method based on a ranging/sidelink positioning protocol according to an example embodiment.

FIG. 7 is a schematic flowchart of a security protection method based on a ranging/sidelink positioning protocol according to an example embodiment.

FIG. 8 is a schematic flowchart of a security protection method based on a ranging/sidelink positioning protocol according to an example embodiment.

FIG. 9 is a schematic flowchart of a security protection method based on a ranging/sidelink positioning protocol according to an example embodiment.

FIG. 10 is a schematic flowchart of a security protection method based on a ranging/sidelink positioning protocol according to an example embodiment.

FIG. 11 is a schematic flowchart of a security protection method based on a ranging/sidelink positioning protocol according to an example embodiment.

FIG. 12 is a schematic flowchart of a security protection method based on a ranging/sidelink positioning protocol according to an example embodiment.

FIG. 13 is a schematic flowchart of a security protection method based on a ranging/sidelink positioning protocol according to an example embodiment.

FIG. 14 is a schematic flowchart of a security protection method based on a ranging/sidelink positioning protocol according to an example embodiment.

FIG. 15 is a schematic flowchart of a security protection method based on a ranging/sidelink positioning protocol according to an example embodiment.

FIG. 16 is a schematic diagram of a security protection apparatus based on a ranging/sidelink positioning protocol according to an example embodiment.

FIG. 17 is a schematic diagram of a security protection apparatus based on a ranging/sidelink positioning protocol according to an example embodiment.

FIG. 18 is a schematic structural diagram of a terminal according to an example embodiment.

FIG. 19 is a block diagram of a base station according to an example embodiment.

### DETAILED DESCRIPTION

Example embodiments will be described in detail herein, examples of which are illustrated in the accompanying drawings. When the following description refers to the drawings, unless otherwise indicated, the same numerals in different drawings indicate the same or similar elements. The embodiments described in the following example embodiments do not represent all implementations consistent with the embodiments of the present disclosure. Rather, they are merely examples of apparatuses and methods consistent with some aspects of the embodiments of the present disclosure as detailed in the appended claims.

The terminology used in the embodiments of the present disclosure is for the purpose of describing particular embodiments only and is not intended to limit the embodiments of the present disclosure. The singular forms “a/an” and “the” used in the embodiments of the present disclosure and the appended claims are also intended to include plural forms unless the context clearly indicates other meanings. It should also be understood that the term “and/or” as used herein refers to and includes any or all possible combinations of one or more associated listed item.

It should be understood that although the terms “first,” “second,” “third,” etc., may be used in the embodiments of the present disclosure to describe various information, these information should not be limited to these terms. These terms are only used to distinguish a same type of information from each other. For example, “first information” may also be referred to as “second information” without departing from the scope of the embodiments of the present disclosure, and similarly, the “second information” may also be referred to as “first information.” Depending on context, the word “if” as used herein may be interpreted as “when” or “upon” or “in response to determining.”

For purposes of brevity and ease of understanding, terms “greater than” or “less than” is used herein in characterizing the size relationship. However, those skilled in the art may understand that the term “greater than” also covers meaning of “greater than or equal to,” and “less than” also covers meaning of “less than or equal to.”

FIG. 1 is a schematic structural diagram of a wireless communication system according to an embodiment of the present disclosure. As shown in FIG. 1, the wireless communication system is a communication system based on a mobile communication technology, and the wireless communication system may include: several user equipments 110 and several base stations 120.

The user equipment 110 may be a device that provides voice and/or data connectivity to a user. The user equipment 110 may communicate with one or more core networks through a radio access network (RAN), and the user equipment 110 may be Internet of Things user equipment, such as a sensor device, a mobile phone, and a computer including the Internet of Things user equipment, for example, may be a fixed, portable, pocket, handheld, computer built-in, or in-vehicle apparatus. For example, a station (STA), a subscriber unit, a subscriber station, a mobile station, a mobile, a remote station, an access point, a remote terminal, an access terminal, a user terminal, a user agent, a user device, or a user equipment. Alternatively, the user equipment 110 may be a device of an unmanned aerial vehicle. Alternatively, the user equipment 110 may be an in-vehicle device. For example, it may be a vehicle computer having a wireless communication function or a wireless user equipment externally connected to a vehicle computer. Alternatively, the user equipment 110 may be a roadside device, for example, a street lamp, a signal light, or another roadside device having a wireless communication function.

The base station 120 may be a network-side device in a wireless communication system. The wireless communication system may be a 4th generation mobile communication (4G) system, also referred to as a long term evolution (LTE) system; or the wireless communication system may be a 5G system, also referred to as a new radio system or a 5G NR system. Alternatively, the wireless communication system may be a next generation system of the 5G system. An access network in the 5G system may be referred to as a new generation-radio access network (NG-RAN).

The base station 120 may be an evolved NodeB (eNB) used in a 4G system. Alternatively, the base station 120 may be a base station (gNB) in a centralized-distributed architecture in a 5G system. When the base station 120 adopts a centralized-distributed architecture, the base station 120 usually includes a central unit (CU) and at least two distributed units (DU). The centralized unit is provided with a protocol stack of a Packet Data Convergence Protocol (PDCP) layer, a Radio Link Control (RLC) layer, and a Media Access Control (MAC) layer; and the distributed unit is provided with a protocol stack of a Physical (PHY) layer, which is not limited in the embodiments of the present disclosure.

A wireless connection may be established between the base station 120 and the user equipment 110 through a wireless air interface. In different implementations, the wireless air interface is a wireless air interface based on a fourth generation mobile communication network technology (4G) standard; or the wireless air interface is a wireless air interface based on a fifth generation mobile communication network technology (5G) standard, for example, the wireless air interface is a new air interface; or the wireless air interface may also be a wireless air interface based on a next generation mobile communication network technology standard of 5G.

In some embodiments, an E2E (End to End) connection may also be established between the user equipments 110. For example, a scenario such as V2V (vehicle to vehicle) communication, V2I (vehicle to infrastructure) communication, and V2P (vehicle to pedestrian) communication in V2X (vehicle to everything) communication.

The user equipment herein may be considered as a terminal device in the following embodiments.

In some embodiments, the wireless communication system may further include a network management device 130.

The several base stations 120 are respectively connected to the network management device 130. The network management device 130 may be a core network device in the wireless communication system, for example, the network management device 130 may be a mobility management entity (MME) in an evolved packet core (EPC). Alternatively, the network management device may be another core network device, for example, a serving gateway (SGW), a public data network gateway (PGW), a policy and charging rules function (PCRF), or a home subscriber server (HSS), etc. An implementation form of the network management device 130 is not limited in the embodiments of the present disclosure.

For ease of understanding by those skilled in the art, the embodiments of the present disclosure list a plurality of implementations to clearly describe the technical solutions of the embodiments of the present disclosure. Certainly, those skilled in the art may understand that the multiple embodiments provided by the embodiments of the present disclosure may be executed separately, or may be executed together with the methods of other embodiments in the embodiments of the present disclosure, or may be executed separately or in combination with some methods in other related technologies; the embodiments of the present disclosure are not limited thereto.

In order to better understand the technical solutions described in any embodiment of the present disclosure, first, application scenarios in related arts are described.

In an embodiment, a procedure based on Ranging/Sidelink Positioning Protocol (RSPP) is similar to a Long Term Evolution Positioning Protocol (LPP) procedure between a terminal and Location Management Function (LMP) over a Non-Access Stratum (NAS), and is the upper layer on top of the PC5 direct communication protocol, used for the Ranging/Sidelink Positioning control signaling interaction between terminals. To realize control of operations for Ranging/Sidelink positioning, following procedures are to be performed:
1. Ranging/Sidelink Positioning device discovery;
2. Direct communication establishment for Ranging/Sidelink Positioning procedure;
3. Ranging/Sidelink Positioning procedure.

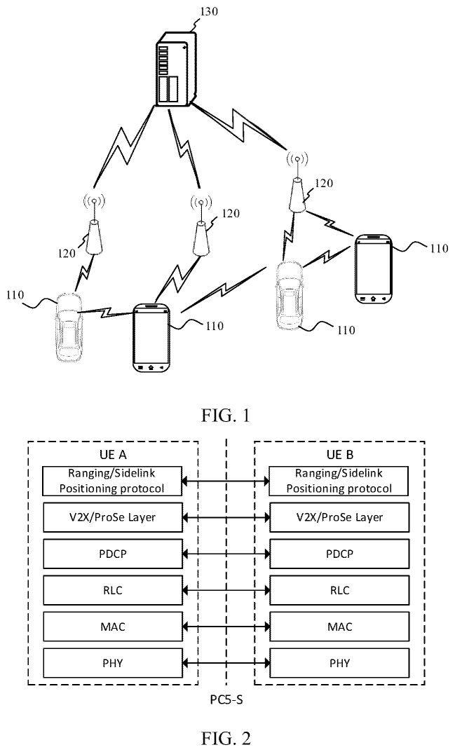

In an embodiment, referring to FIG. 2, for device discovery and direct communication establishment for Ranging/Sidelink Positioning, it is proposed that the Model A and Model B direct discovery are reused as basis for Ranging/Sidelink Positioning devices discovery, and the existing unicast mode 5G ProSe (Proximity Service) Direct Communication establishment procedure are reused.

As RSPP is established on top of the existing PC5 direct communication protocol, the security protection of direct communication over RSPP can rely on the existing security protection of PC5 direct communication, according to which the activation of PC5 link security for direct communication relies on the PC5 security policies provisioned to the terminals by the network. The PC5 security policies are defined based on the security requirements of the specific ProSe applications/services run between the terminals, i.e. PC5 security policies provisioned by the network are associated with ProSe applications/services supported and requested by the terminals.

However, when reusing the existing security activation mechanism of PC5 direct communication for RSPP protection, the security policies for RSPP may not be the same as the security policies for ProSe applications/services, because the security requirements of Ranging/Sidelink Positioning services are very likely different from those of the ProSe applications/services. Therefore, how the security requirements of Ranging/Sidelink Positioning services could be correctly applied on the protection of RSPP layer between terminals needs to be studied.

In an embodiment, security policies based on PC5 link can be provisioned by the network via configuring a list of ProSe applications/services that require security protection and the PC5 security policies for each of the ProSe applications/services in the list, i.e. the PC5 security policies are based on the security requirements of the corresponding ProSe applications/services.

In an embodiment, RSPP is used for controlling the operations for Ranging/Sidelink Positioning service and carries the coordination and configuration information (e.g. Ranging capability, Ranging assistance data) and Ranging/Sidelink Positioning measurement result exchanged between the terminals. If the configuration information or the measurement result is tampered with by an attacker through an air interface, the Ranging/SL positioning service cannot provide correct terminal positioning data. Therefore, integrity protection for the control signaling exchanged over RSPP between the terminals shall be required. As the position measurement result can be used to derive the location of the involved terminals, who may not want their location information to be leaked to a third party not involved in the Ranging/Sidelink Positioning service. Therefore, confidentiality protection of the control signaling exchanged over RSPP between the terminals may also be required to protect the location information of the involved terminals.

As shown in FIG. 3, an embodiment provides a security protection method based on a ranging/sidelink positioning protocol, performed by a network function, including:
Step 31, sending ranging/sidelink positioning protocol security policy information to a terminal;
wherein the ranging/sidelink positioning protocol security policy information indicates a security policy for the terminal to perform a ranging/sidelink positioning protocol procedure.

The terminal involved in the present disclosure may include, but is not limited to, a mobile phone, a wearable device, a vehicle-mounted terminal, a road side unit (RSU), a smart home terminal, an industrial sensing device, a medical device, and/or the like. In some embodiments, the terminal may be a Redcap terminal or a new radio (NR) terminal of a predetermined version (for example, a R17 NR terminal).

In the embodiments of the present disclosure, the network function may be a policy control function (PCF), a 5G proximity service key management function (PKMF) or a 5G proximity service direct discovery name management function (DDNMF).

In an embodiment, the ranging/sidelink positioning protocol security policy information is sent to the terminal by the network function; where the ranging/sidelink positioning protocol security policy information indicates the security policy for the terminal to perform the ranging/sidelink positioning protocol procedure.

An access network device involved in the present disclosure may be a base station, for example, a base station of a third generation mobile communication (3G) network, a base station of a fourth generation mobile communication (4G) network, a base station of a fifth generation mobile communication (5G) network, or other evolved base stations.

The ranging/sidelink positioning protocol herein may be a protocol associated with ranging/SL positioning. The ranging/sidelink positioning protocol may be a Ranging/Sidelink Positioning Protocol (RSPP).

In an embodiment, RSPP security policy information is sent to the terminal, where the RSPP security policy information indicates: a security policy for the terminal to perform an RSPP procedure over a PC5 interface or a PC5-S interface.

In an embodiment, RSPP security policy information is sent to the terminal, where the RSPP security policy information indicates a mapping relation between at least one ranging/sidelink positioning service and a corresponding RSPP security policy. Different ranging/sidelink positioning services may correspond to a same RSPP security policy; or different ranging/sidelink positioning services may correspond to different RSPP security policies. It should be noted that after receiving the RSPP security policy information, the terminal may store the mapping relation in a predetermined area, for example, as a list, to facilitate query. In this way, after determining a ranging/sidelink positioning service to be initiated, the terminal may determine the RSPP security policy based on the ranging/sidelink positioning service and the mapping relation by querying the list.

In an embodiment, RSPP security policy information is sent to the terminal, where the RSPP security policy information includes at least one of:
signaling integrity protection information, indicating a following RSPP policy:
   the terminal only accepts a connection when a PC5 interface is under integrity protection;
signaling confidentiality protection information, indicating one of following RSPP policies:
   the terminal only accepts a connection when a PC5 interface is under confidentiality protection;
   the terminal only establishes a connection without confidentiality protection;
   the terminal tries to establish confidentiality protection and accepts a connection without confidentiality protection.

An identifier “REQUIRED” may be used to indicate “the terminal only accepts a connection when a PC5 interface is under integrity protection” and “the terminal only accepts a connection when a PC5 interface is under confidentiality protection.” An identifier “NOT NEEDED” may be used to indicate “the terminal only establishes a connection without confidentiality protection.” An identifier “PREFERRED” may be used to indicate “the terminal tries to establish confidentiality protection and accepts a connection without confidentiality protection.” One use of “PREFERRED” is to enable a security policy to be changed without updating all involved terminals at once.

In an embodiment, the RSPP security policy may be configured separately from the security policy of the ProSe applications or services.

It should be noted that as the RSPP is a signaling protocol and is carried over PC5-S interface, there is hence no User Plane security policies configured in the RSPP security policies.

In an embodiment, the network function is a policy control function (PCF); and the RSPP security policy information is sent to the terminal during a service authorization and configuration procedure.

In an embodiment, the network function is a 5G proximity service key management function (PKMF) or a 5G proximity service direct discovery name management function (DDNMF); and the RSPP security policy information is sent to the terminal during a terminal discovery procedure.

In an embodiment of the present disclosure, the network function sends the RSPP security policy information to the terminal, where the RSPP security policy information indicates a security policy for the terminal to perform an RSPP procedure. As the RSPP security policy information indicates the security policy for the terminal to perform the RSPP procedure, after receiving the RSPP security policy information, the terminal may perform the RSPP procedure based on the security policy indicated by the RSPP security policy information, and compared with a manner of performing the RSPP procedure not based on the security policy, security of inter-terminal ranging/sidelink communication is improved.

It should be noted that those skilled in the art may understand that the method provided in the embodiments of the present disclosure may be performed separately, or may be performed together with some methods in the embodiments of the present disclosure or some methods in related technologies.

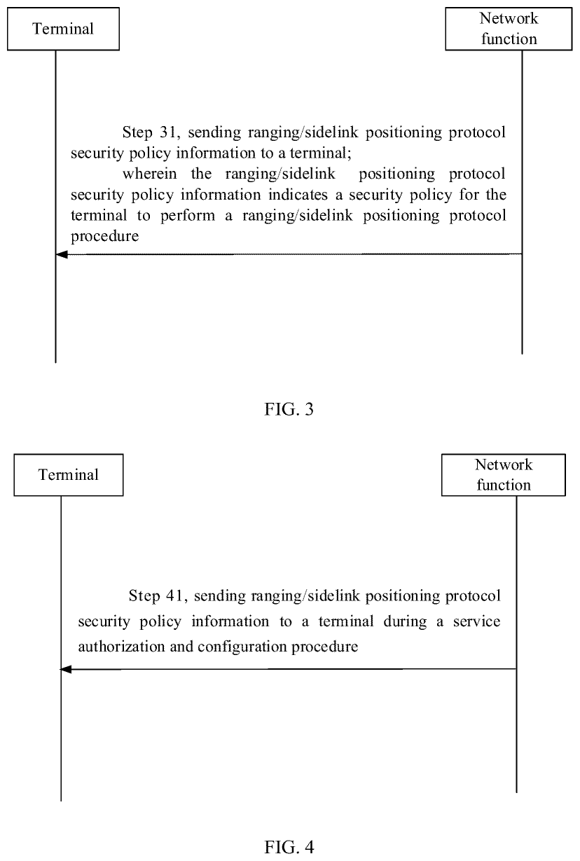

As shown in FIG. 4, an embodiment provides a security protection method based on a ranging/sidelink positioning protocol, performed by a network function, where the network function is a policy control function (PCF); and the method includes:
Step 41, sending ranging/sidelink positioning protocol security policy information to a terminal during a service authorization and configuration procedure.

In an embodiment, RSPP security policy information is sent to the terminal during the service authorization and configuration procedure, where the RSPP security policy information indicates a mapping relation between at least one ranging/sidelink positioning service and a corresponding RSPP security policy.

In an embodiment, RSPP security policy information is sent to the terminal during the service authorization and configuration procedure, where the RSPP security policy information includes at least one of:
signaling integrity protection information, indicating a following RSPP policy:
   the terminal only accepts a connection when a PC5 interface is under integrity protection;
signaling confidentiality protection information, indicating one of following RSPP policies:
   the terminal only accepts a connection when a PC5 interface is under confidentiality protection;
   the terminal only establishes a connection without confidentiality protection;
   the terminal tries to establish confidentiality protection and accepts a connection without confidentiality protection.

It should be noted that those skilled in the art may understand that the method provided in the embodiments of the present disclosure may be performed separately, or may be performed together with some methods in the embodiments of the present disclosure or some methods in related technologies.

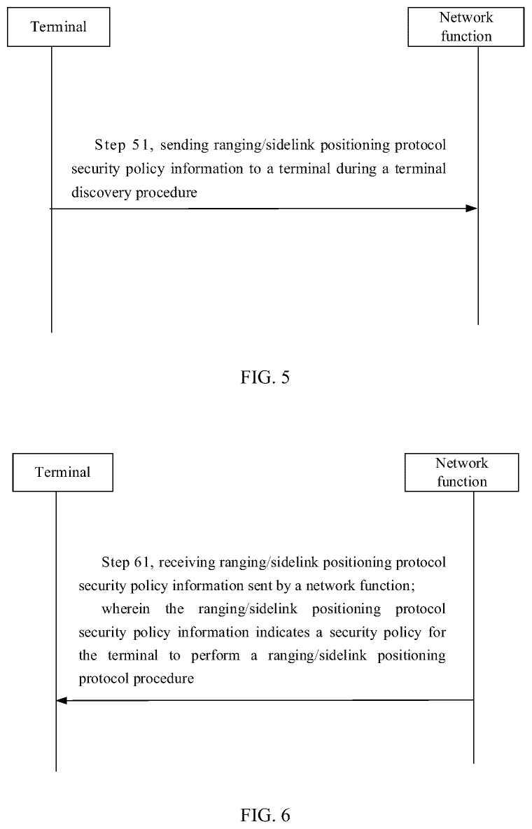

As shown in FIG. 5, an embodiment provides a security protection method based on a ranging/sidelink positioning protocol, performed by a network function, where the network function is a 5G proximity service key management function (PKMF) or a 5G proximity service direct discovery name management function (DDNMF); and the method includes:
Step 51, sending ranging/sidelink positioning protocol security policy information to a terminal during a terminal discovery procedure.

In an embodiment, RSPP security policy information is sent to the terminal during the terminal discovery procedure, where the RSPP security policy information indicates a mapping relation between at least one ranging/sidelink positioning service and a corresponding RSPP security policy.

In an embodiment, RSPP security policy information is sent to the terminal during the terminal discovery procedure, where the RSPP security policy information includes at least one of:
signaling integrity protection information, indicating a following RSPP policy:
   the terminal only accepts a connection when a PC5 interface is under integrity protection;
signaling confidentiality protection information, indicating one of following RSPP policies:
   the terminal only accepts a connection when a PC5 interface is under confidentiality protection;
   the terminal only establishes a connection without confidentiality protection;
   the terminal tries to establish confidentiality protection and accepts a connection without confidentiality protection.

It should be noted that those skilled in the art may understand that the method provided in the embodiments of the present disclosure may be performed separately, or may be performed together with some methods in the embodiments of the present disclosure or some methods in related technologies.

As shown in FIG. 6, an embodiment provides a security protection method based on a ranging/sidelink positioning protocol, performed by a terminal, including:
Step 61, receiving ranging/sidelink positioning protocol security policy information sent by a network function;
wherein the ranging/sidelink positioning protocol security policy information indicates a security policy for the terminal to perform a ranging/sidelink positioning protocol procedure.

The terminal involved in the present disclosure may include, but is not limited to, a mobile phone, a wearable device, a vehicle-mounted terminal, a road side unit (RSU), a smart home terminal, an industrial sensing device, a medical device, and/or the like. In some embodiments, the terminal may be a Redcap terminal or a new radio (NR) terminal of a predetermined version (for example, a R17 NR terminal).

In the embodiments of the present disclosure, the network function may be a policy control function (PCF), a 5G proximity service key management function (PKMF) or a 5G proximity service direct discovery name management function (DDNMF).

In an embodiment, the ranging/sidelink positioning protocol security policy information sent by the network function is received; where the ranging/sidelink positioning protocol security policy information indicates: the security policy for the terminal to perform an RSPP procedure.

An access network device involved in the present disclosure may be a base station, for example, a base station of a third generation mobile communication (3G) network, a base station of a fourth generation mobile communication (4G) network, a base station of a fifth generation mobile communication (5G) network, or other evolved base stations.

The ranging/sidelink positioning protocol herein may be a protocol associated with ranging/SL positioning. The ranging/sidelink positioning protocol may be a Ranging/Sidelink Positioning Protocol (RSPP).

In an embodiment, RSPP security policy information sent by the network function is received, where the RSPP security policy information indicates: a security policy for the terminal to perform an RSPP procedure over a PC5 interface or a PC5-S interface.

In an embodiment, RSPP security policy information sent by the network function is received, where the RSPP security policy information indicates a mapping relation between at least one ranging/sidelink positioning service and a corresponding RSPP security policy. Different ranging/sidelink positioning services may correspond to a same RSPP security policy; or different ranging/sidelink positioning services may correspond to different RSPP security policies. It should be noted that after receiving the RSPP security policy information, the terminal may store the mapping relation in a predetermined area, for example, as a list, to facilitate query. In this way, after determining a ranging/sidelink positioning service to be initiated, the terminal may determine the RSPP security policy based on the ranging/sidelink positioning service and the mapping relation by querying the list.

In an embodiment, RSPP security policy information sent by the network function is received, where the RSPP security policy information includes at least one of:
signaling integrity protection information, indicating a following RSPP policy:
   the terminal only accepts a connection when a PC5 interface is under integrity protection;
signaling confidentiality protection information, indicating one of following RSPP policies:
   the terminal only accepts a connection when a PC5 interface is under confidentiality protection;
   the terminal only establishes a connection without confidentiality protection;
   the terminal tries to establish confidentiality protection and accepts a connection without confidentiality protection.

An identifier “REQUIRED” may be used to indicate “the terminal only accepts a connection when a PC5 interface is under integrity protection” and “the terminal only accepts a connection when a PC5 interface is under confidentiality protection.” An identifier “NOT NEEDED” may be used to indicate “the terminal only establishes a connection without confidentiality protection.” An identifier “PREFERRED” may be used to indicate “the terminal tries to establish confidentiality protection and accepts a connection without confidentiality protection.” One use of “PREFERRED” is to enable a security policy to be changed without updating all involved terminals at once.

In an embodiment, the RSPP security policy may be configured separately from the security policy of the ProSe applications or services.

It should be noted that as the RSPP is a signaling protocol and is carried over PC5-S interface, there are, hence, no User Plane security policies configured in the RSPP security policies.

In an embodiment, the network function is a policy control function (PCF); and the RSPP security policy information sent by the network function is received during a service authorization and configuration procedure.

In an embodiment, the network function is a 5G proximity service key management function (PKMF) or a 5G proximity service direct discovery name management function (DDNMF); and the RSPP security policy information sent by the network function is received during a terminal discovery procedure.

In an embodiment, the terminal is a first terminal initiating direct communication; the RSPP security policy information sent by the network function is received; where the RSPP security policy information indicates the security policy for the terminal to perform the RSPP procedure. in response to determining that the first terminal discovers a second terminal, determining that the direct communication is established for a ranging/sidelink positioning service rather than for a proximity service (ProSe).

In an embodiment, the terminal is a first terminal initiating direct communication; the RSPP security policy information sent by the network function is received; where the RSPP security policy information indicates the security policy for the terminal to perform the RSPP procedure. In response to determining that the first terminal discovers a second terminal, it is determined that the direct communication is established for a ranging/sidelink positioning service rather than for a proximity service (ProSe). A RSPP security policy of the first terminal to be sent to the second terminal is chosen based on the RSPP security policy information. The RSPP security policy of the first terminal, or security capability information of the first terminal, or both, is sent to the second terminal.

In an embodiment, the RSPP security policy of the first terminal, or the security capability information of the first terminal, or both, is sent to the second terminal through a direct communication request message.

In an embodiment, the terminal is a discovered second terminal for direct communication; the RSPP security policy of the first terminal, or the security capability information of the first terminal, or both, sent by the first terminal initiating the direct communication is received.

In an embodiment, the RSPP security policy of the first terminal, or the security capability information of the first terminal, or both, sent by the first terminal is received through a direct communication request message.

In an embodiment, the terminal is a discovered second terminal for direct communication; the RSPP security policy of the first terminal, or the security capability information of the first terminal, or both, sent by the first terminal initiating the direct communication is received. The direct communication request message is rejected in response to determining that the RSPP security policy of the first terminal indicates that the terminal only establishes a connection without integrity protection; or the direct communication request message is rejected in response to determining that the RSPP security policy of the first terminal indicates that the terminal only establishes a connection without confidentiality protection, and the RSPP security policy of the second terminal indicates that the terminal only accepts a connection when a PC5 interface is under confidentiality protection; or the direct communication request message is rejected in response to determining that the RSPP security policy of the first terminal indicates that the terminal only accepts a connection when a PC5 interface is under confidentiality protection, and the RSPP security policy of the second terminal indicates that the terminal only establishes a connection without confidentiality protection.

In an embodiment, the terminal is a discovered second terminal for direct communication; the RSPP security policy of the first terminal, or the security capability information of the first terminal, or both, sent by the first terminal initiating the direct communication is received. In response to determining to reject the direct communication request message based on the RSPP security policy, the second terminal initiates a direct authentication procedure, or a key establishment procedure, or both, with the first terminal.

In an embodiment, the terminal is a discovered second terminal for direct communication; the RSPP security policy of the first terminal, or the security capability information of the first terminal, or both, sent by the first terminal initiating the direct communication is received. The direct communication request message is accepted in response to determining that both the RSPP security policy of the first terminal and a RSPP security policy of the second terminal indicate that the terminal only establishes a connection without confidentiality protection; the direct communication request message is accepted in response to determining that both the RSPP security policy of the first terminal and the RSPP security policy of the second terminal indicate that the terminal only accepts a connection when a PC5 interface is under confidentiality protection; the direct communication request message is accepted in response to determining that the RSPP security policy of the first terminal indicates that the terminal only establishes a connection without confidentiality protection, and the RSPP security policy of the second terminal indicates that the terminal tries to establish confidentiality protection and accepts a connection without confidentiality protection; the direct communication request message is accepted in response to determining that the RSPP security policy of the first terminal indicates that the terminal tries to establish confidentiality protection and accepts a connection without confidentiality protection, and the RSPP security policy of the second terminal indicates that the terminal only establishes a connection without confidentiality protection; the direct communication request message is accepted in response to determining that the RSPP security policy of the first terminal indicates that the terminal only accepts a connection when a PC5 interface is under confidentiality protection, and the RSPP security policy of the second terminal indicates that the terminal tries to establish confidentiality protection and accepts a connection without confidentiality protection; or the direct communication request message is accepted in response to determining that the RSPP security policy of the first terminal indicates that the terminal tries to establish confidentiality protection and accepts a connection without confidentiality protection, and the RSPP security policy of the second terminal indicates that the terminal only accepts a connection when a PC5 interface is under confidentiality protection.

In an embodiment, the terminal is a discovered second terminal for direct communication; the RSPP security policy of the first terminal, or the security capability information of the first terminal, or both, sent by the first terminal initiating the direct communication is received. The RSPP security policy is determined to be adopted in response to determining to accept the direct communication request message based on the RSPP security policy. In response to determining to adopt the RSPP security policy, a security algorithm for integrity protection, or confidentiality protection, or both, is determined based on the security capability information of the first terminal and security capability information of the second terminal.

In an embodiment, the terminal is a discovered second terminal for direct communication; the RSPP security policy of the first terminal, or the security capability information of the first terminal, or both, sent by the first terminal initiating the direct communication is received. The RSPP security policy is determined to be adopted in response to determining to accept the direct communication request message based on the RSPP security policy. In response to determining to adopt the RSPP security policy, a security algorithm for integrity protection, or confidentiality protection, or both, is determined based on the security capability information of the first terminal and security capability information of the second terminal. At least one of: information of the security algorithm, the RSPP security policy of the first terminal, or the security capability information of the first terminal is sent to the first terminal.

In an embodiment, at least one of: the information of the security algorithm, the RSPP security policy of the first terminal, or the security capability information of the first terminal is sent to the first terminal through a direct security mode command message.

In an embodiment, the direct security mode command message is integrity protected with the security algorithm chosen for integrity protection.

It should be noted that those skilled in the art may understand that the method provided in the embodiments of the present disclosure may be performed separately, or may be performed together with some methods in the embodiments of the present disclosure or some methods in related technologies.

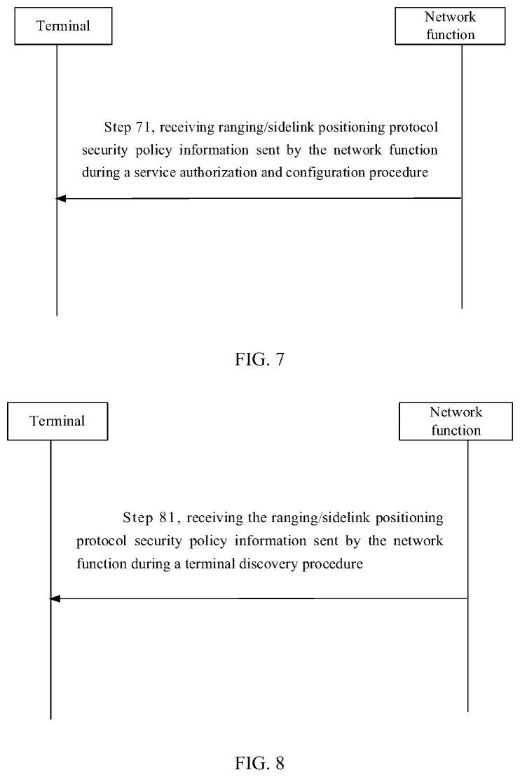

As shown in FIG. 7, an embodiment provides a security protection method based on a ranging/sidelink positioning protocol, performed by a terminal, where a network function is a policy control function (PCF); and the method includes:
Step 71, receiving ranging/sidelink positioning protocol security policy information sent by the network function during a service authorization and configuration procedure.

In an embodiment, the network function is a policy control function (PCF); and the RSPP security policy information sent by the network function is received during a service authorization and configuration procedure. The RSPP security policy information indicates a mapping relation between at least one ranging/sidelink positioning service and a corresponding RSPP security policy. Alternatively, the RSPP security policy information includes at least one of:
signaling integrity protection information, indicating a following RSPP policy:
   the terminal only accepts a connection when a PC5 interface is under integrity protection;
signaling confidentiality protection information, indicating one of following RSPP policies: the terminal only accepts a connection when a PC5 interface is under confidentiality protection;
   the terminal only establishes a connection without confidentiality protection;
   the terminal tries to establish confidentiality protection and accepts a connection without confidentiality protection.

It should be understood that the terminal in this embodiment may be a first terminal initiating direct communication or a discovered second terminal for the direct communication.

It should be noted that those skilled in the art may understand that the method provided in the embodiments of the present disclosure may be performed separately, or may be performed together with some methods in the embodiments of the present disclosure or some methods in related technologies.

As shown in FIG. 8, an embodiment provides a security protection method based on a ranging/sidelink positioning protocol, performed by a terminal, where a network function is a 5G proximity service key management function (PKMF) or a 5G proximity service direct discovery name management function (DDNMF); and the method includes:
Step 81, receiving the ranging/sidelink positioning protocol security policy information sent by the network function during a terminal discovery procedure.

In an embodiment, the network function is a 5G proximity service key management function (PKMF) or a 5G proximity service direct discovery name management function (DDNMF); and the RSPP security policy information sent by the network function is received during a terminal discovery procedure. The RSPP security policy information indicates a mapping relation between at least one ranging/sidelink positioning service and a corresponding RSPP security policy. Alternatively, the RSPP security policy information includes at least one of:
signaling integrity protection information, indicating a following RSPP policy:
   the terminal only accepts a connection when a PC5 interface is under integrity protection;
signaling confidentiality protection information, indicating one of following RSPP policies:
   the terminal only accepts a connection when a PC5 interface is under confidentiality protection;
   the terminal only establishes a connection without confidentiality protection;
   the terminal tries to establish confidentiality protection and accepts a connection without confidentiality protection.

It should be understood that the terminal in this embodiment may be a first terminal initiating direct communication or a discovered second terminal for the direct communication.

It should be noted that those skilled in the art may understand that the method provided in the embodiments of the present disclosure may be performed separately, or may be performed together with some methods in the embodiments of the present disclosure or some methods in related technologies.

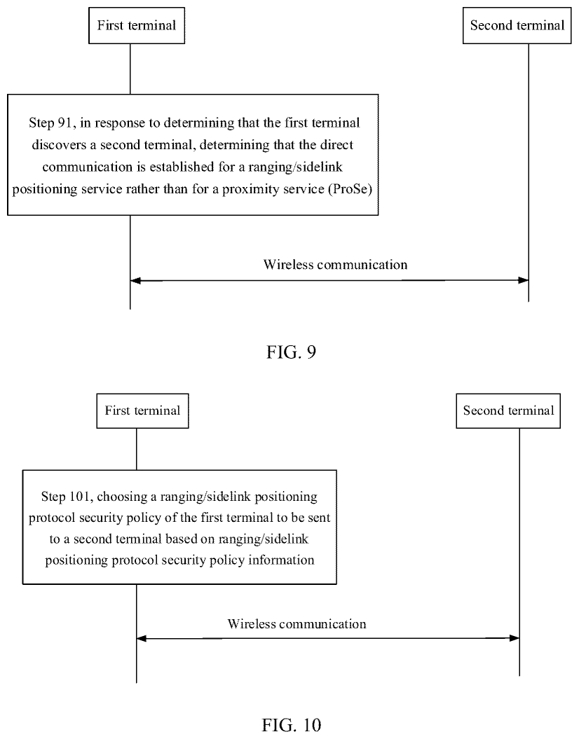

As shown in FIG. 9, an embodiment provides a security protection method based on a ranging/sidelink positioning protocol, performed by a terminal, where the terminal is a first terminal initiating direct communication, and the method includes:
Step 91, in response to determining that the first terminal discovers a second terminal, determining that the direct communication is established for a ranging/sidelink positioning service rather than for a proximity service (ProSe).

It should be understood that, the first terminal is the terminal initiating the direct communication, and the second terminal is a discovered terminal for the direct communication, and the first terminal and the second terminal have already been described in detail in the above embodiments, which will not be repeated herein.

In an embodiment, RSPP security policy information sent by a network function is received, where the RSPP security policy information indicates: a security policy for the terminal to perform an RSPP procedure. In response to receiving the RSPP security policy information and determining that the first terminal discovers the second terminal, determining that the direct communication is established for a ranging/sidelink positioning service rather than for a proximity service (ProSe).

It should be noted that those skilled in the art may understand that the method provided in the embodiments of the present disclosure may be performed separately, or may be performed together with some methods in the embodiments of the present disclosure or some methods in related technologies.

As shown in FIG. 10, an embodiment provides a security protection method based on a ranging/sidelink positioning protocol, performed by a terminal, where the terminal is a first terminal initiating direct communication, and the method includes:
Step 101, choosing a ranging/sidelink positioning protocol security policy of the first terminal to be sent to a second terminal based on ranging/sidelink positioning protocol security policy information.

In an embodiment, RSPP security policy information sent by a network function is received, where the RSPP security policy information indicates: a security policy for the terminal to perform an RSPP procedure. In response to receiving the RSPP security policy information and determining that the first terminal discovers the second terminal, determining that the direct communication is established for a ranging/sidelink positioning service rather than for a proximity service (ProSe). A RSPP security policy of the first terminal to be sent to the second terminal is chosen based on the RSPP security policy information.

It should be understood that, the first terminal is the terminal initiating the direct communication, and the second terminal is a discovered terminal for the direct communication, and the first terminal and the second terminal have already been described in detail in the above embodiments, which will not be repeated herein. It should be noted that those skilled in the art may understand that the method provided in the embodiments of the present disclosure may be performed separately, or may be performed together with some methods in the embodiments of the present disclosure or some methods in related technologies.

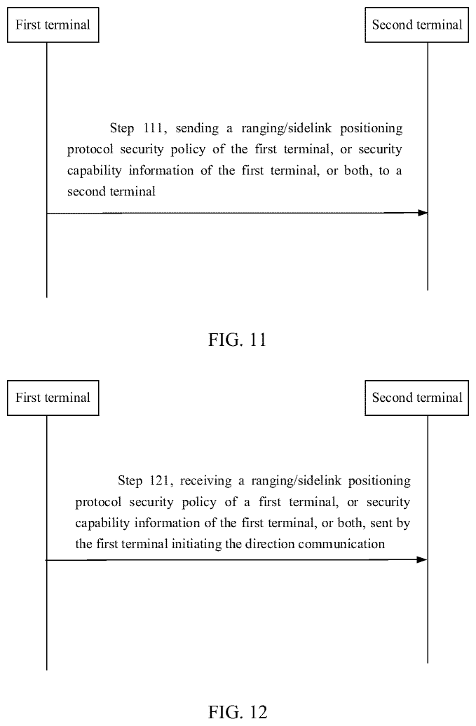

As shown in FIG. 11, an embodiment provides a security protection method based on a ranging/sidelink positioning protocol, performed by a terminal, where the terminal is a first terminal initiating direct communication, and the method includes:
Step 111, sending a ranging/sidelink positioning protocol security policy of the first terminal, or security capability information of the first terminal, or both, to a second terminal.

In an embodiment, RSPP security policy information sent by a network function is received, where the RSPP security policy information indicates: a security policy for the terminal to perform an RSPP procedure. In response to receiving the RSPP security policy information and determining that the first terminal discovers the second terminal, determining that the direct communication is established for a ranging/sidelink positioning service rather than for a proximity service (ProSe). A RSPP security policy of the first terminal to be sent to the second terminal is chosen based on the RSPP security policy information. The RSPP security policy of the first terminal, or security capability information of the first terminal, or both, is sent to the second terminal.

In an embodiment, the RSPP security policy of the first terminal, or the security capability information of the first terminal, or both, is sent to the second terminal through a direct communication request message.

In an embodiment, the RSPP security policy of the first terminal, or security capability information of the first terminal, or both, is sent to the second terminal. At least one of: information of the security algorithm, the RSPP security policy of the first terminal, or the security capability information of the first terminal sent by the second terminal is received.

In an embodiment, at least one of: the information of the security algorithm, the ranging/sidelink positioning protocol security policy of the first terminal, or the security capability information of the first terminal sent by the second terminal is received through a direct security mode command message.

It should be understood that, the first terminal is the terminal initiating the direct communication, and the second terminal is a discovered terminal for the direct communication, and the first terminal and the second terminal have already been described in detail in the above embodiments, which will not be repeated herein.

It should be noted that, in some scenarios, the first terminal may not send the security capability information of the first terminal. It may be understood that, in some scenarios, the first terminal does not need to provide the security capability information of the first terminal to the second terminal, for example, the second terminal pre-stores the security capability information of the first terminal, which is not limited herein.

It should be noted that the first terminal needs to send the ranging/sidelink positioning protocol security policy of the first terminal to the second terminal.

It should be noted that those skilled in the art may understand that the method provided in the embodiments of the present disclosure may be performed separately, or may be performed together with some methods in the embodiments of the present disclosure or some methods in related technologies.

As shown in FIG. 12, an embodiment provides a security protection method based on a ranging/sidelink positioning protocol, performed by a terminal, where the terminal is a discovered second terminal for direct communication, and the method includes:
Step 121, receiving a ranging/sidelink positioning protocol security policy of a first terminal, or security capability information of the first terminal, or both, sent by the first terminal initiating the direction communication.

In an embodiment, the RSPP security policy of the first terminal, or the security capability information of the first terminal, or both, sent by the first terminal is received through a direct communication request message.

In an embodiment, the RSPP security policy of the first terminal, or the security capability information of the first terminal, or both, sent by the first terminal initiating direct communication is received. The direct communication request message is rejected in response to determining that the RSPP security policy of the first terminal indicates that the terminal only establishes a connection without integrity protection; or the direct communication request message is rejected in response to determining that the RSPP security policy of the first terminal indicates that the terminal only establishes a connection without confidentiality protection, and the RSPP security policy of the second terminal indicates that the terminal only accepts a connection when a PC5 interface is under confidentiality protection; or the direct communication request message is rejected in response to determining that the RSPP security policy of the first terminal indicates that the terminal only accepts a connection when a PC5 interface is under confidentiality protection, and the RSPP security policy of the second terminal indicates that the terminal only establishes a connection without confidentiality protection.

In an embodiment, the RSPP security policy of the first terminal, or the security capability information of the first terminal, or both, sent by the first terminal initiating direct communication is received. The direct communication request message is accepted in response to determining that both the RSPP security policy of the first terminal and a RSPP security policy of the second terminal indicate that the terminal only establishes a connection without confidentiality protection; the direct communication request message is accepted in response to determining that both the RSPP security policy of the first terminal and the RSPP security policy of the second terminal indicate that the terminal only accepts a connection when a PC5 interface is under confidentiality protection; the direct communication request message is accepted in response to determining that the RSPP security policy of the first terminal indicates that the terminal only establishes a connection without confidentiality protection, and the RSPP security policy of the second terminal indicates that the terminal tries to establish confidentiality protection and accepts a connection without confidentiality protection; the direct communication request message is accepted in response to determining that the RSPP security policy of the first terminal indicates that the terminal tries to establish confidentiality protection and accepts a connection without confidentiality protection, and the RSPP security policy of the second terminal indicates that the terminal only establishes a connection without confidentiality protection; the direct communication request message is accepted in response to determining that the RSPP security policy of the first terminal indicates that the terminal only accepts a connection when a PC5 interface is under confidentiality protection, and the RSPP security policy of the second terminal indicates that the terminal tries to establish confidentiality protection and accepts a connection without confidentiality protection; or the direct communication request message is accepted in response to determining that the RSPP security policy of the first terminal indicates that the terminal tries to establish confidentiality protection and accepts a connection without confidentiality protection, and the RSPP security policy of the second terminal indicates that the terminal only accepts a connection when a PC5 interface is under confidentiality protection.

It should be understood that, the first terminal is the terminal initiating the direct communication, and the second terminal is a discovered terminal for the direct communication, and the first terminal and the second terminal have already been described in detail in the above embodiments, which will not be repeated herein.

It should be noted that those skilled in the art may understand that the method provided in the embodiments of the present disclosure may be performed separately, or may be performed together with some methods in the embodiments of the present disclosure or some methods in related technologies.

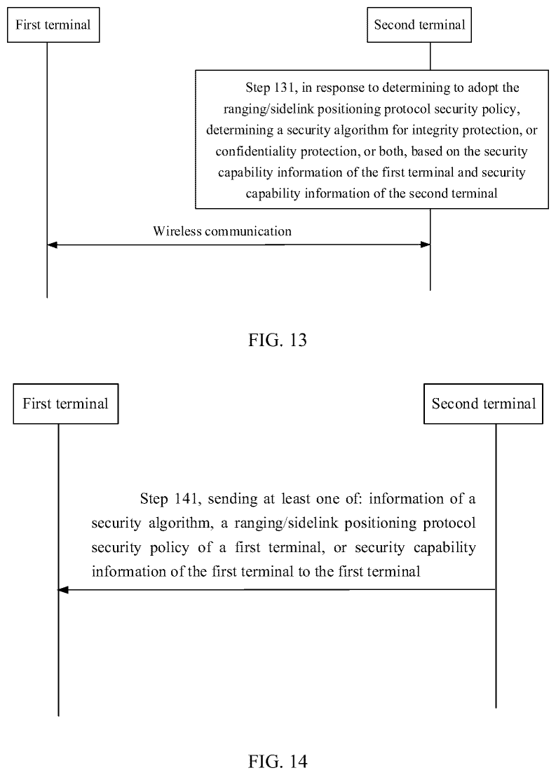

As shown in FIG. 13, an embodiment provides a security protection method based on a ranging/sidelink positioning protocol, performed by a terminal, where the terminal is a discovered second terminal for direct communication, and the method includes:
Step 131, in response to determining to adopt the ranging/sidelink positioning protocol security policy, determining a security algorithm for integrity protection, or confidentiality protection, or both, based on the security capability information of the first terminal and security capability information of the second terminal.

In an embodiment, the terminal is a discovered second terminal for direct communication; the RSPP security policy of the first terminal, or the security capability information of the first terminal, or both, sent by the first terminal initiating the direct communication is received. The RSPP security policy is determined to be adopted in response to determining to accept the direct communication request message based on the RSPP security policy. In response to determining to adopt the RSPP security policy, a security algorithm for integrity protection, or confidentiality protection, or both, is determined based on the security capability information of the first terminal and security capability information of the second terminal.

In an embodiment, the terminal is a discovered second terminal for direct communication; the RSPP security policy of the first terminal, or the security capability information of the first terminal, or both, sent by the first terminal initiating the direct communication is received. The RSPP security policy is determined to be adopted in response to determining to accept the direct communication request message based on the RSPP security policy. In response to determining to adopt the RSPP security policy, a security algorithm for integrity protection, or confidentiality protection, or both, is determined based on the security capability information of the first terminal and security capability information of the second terminal. At least one of: information of the security algorithm, the RSPP security policy of the first terminal, or the security capability information of the first terminal is sent to the first terminal.

In an embodiment, at least one of: the information of the security algorithm, the RSPP security policy of the first terminal, or the security capability information of the first terminal is sent to the first terminal through a direct security mode command message.

In an embodiment, the direct security mode command message is integrity protected with the security algorithm chosen for integrity protection.

It should be understood that, the first terminal is the terminal initiating the direct communication, and the second terminal is a discovered terminal for the direct communication, and the first terminal and the second terminal have already been described in detail in the above embodiments, which will not be repeated herein.

It should be noted that those skilled in the art may understand that the method provided in the embodiments of the present disclosure may be performed separately, or may be performed together with some methods in the embodiments of the present disclosure or some methods in related technologies.

As shown in FIG. 14, an embodiment provides a security protection method based on a ranging/sidelink positioning protocol, performed by a terminal, where the terminal is a discovered second terminal for direct communication, and the method includes:
Step 141, sending at least one of: information of a security algorithm, a ranging/sidelink positioning protocol security policy of a first terminal, or security capability information of the first terminal to the first terminal.

In an embodiment, the terminal is a discovered second terminal for direct communication; the RSPP security policy of the first terminal, or the security capability information of the first terminal, or both, sent by the first terminal initiating the direct communication is received. The RSPP security policy is determined to be adopted in response to determining to accept the direct communication request message based on the RSPP security policy. In response to determining to adopt the RSPP security policy, a security algorithm for integrity protection, or confidentiality protection, or both, is determined based on the security capability information of the first terminal and security capability information of the second terminal. At least one of: information of the security algorithm, the RSPP security policy of the first terminal, or the security capability information of the first terminal is sent to the first terminal.

In an embodiment, at least one of: the information of the security algorithm, the RSPP security policy of the first terminal, or the security capability information of the first terminal is sent to the first terminal through a direct security mode command message.

In an embodiment, the direct security mode command message is integrity protected with the security algorithm chosen for integrity protection.

It should be understood that, the first terminal is the terminal initiating the direct communication, and the second terminal is a discovered terminal for the direct communication, and the first terminal and the second terminal have already been described in detail in the above embodiments, which will not be repeated herein.

It should be noted that those skilled in the art may understand that the method provided in the embodiments of the present disclosure may be performed separately, or may be performed together with some methods in the embodiments of the present disclosure or some methods in related technologies.

In order to better understand the embodiments of the present disclosure, the technical solution of the present disclosure is further described below with reference to an example embodiment.

### Example 1

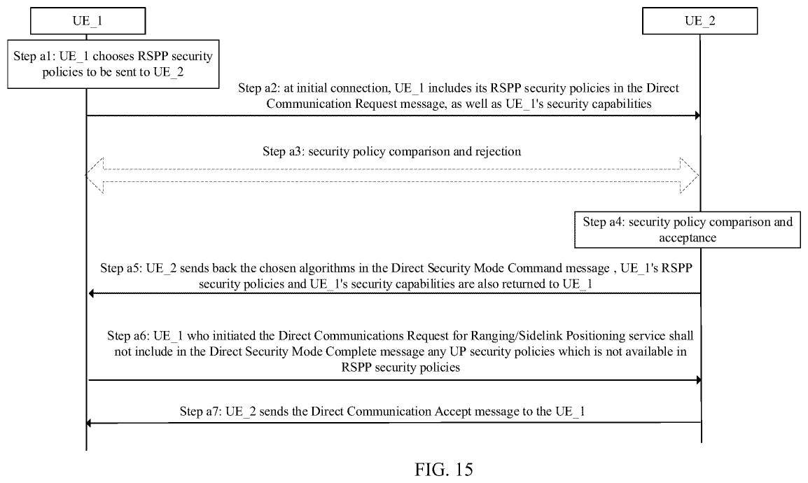

Referring to FIG. 15, this embodiment provides a security protection method based on a ranging/sidelink positioning protocol (RSPP), including:
Step a1: UE_1 chooses RSPP security policies to be sent to UE_2.A UE supporting Ranging/SL Positioning must also support ProSe/V2X. Therefore, it is possible that a UE may be provisioned with both PC5 security policies for ProSe/V2X services and RSPP security polices for Ranging/Sidelink Positioning services. In this case, after two UEs have discovered each other for Ranging/Sidelink Positioning, the UE initiating direct communication over PC5 (UE_1) shall be able to decide that the direct communication is established for Ranging/Sidelink Positioning service rather than for ProSe service, so that UE_1 is able to choose RSPP security policies to be sent to the receiving UE (UE_2) rather than PC5 security policies for ProSe/V2X services.
Step a2: at initial connection, UE_1 includes its RSPP security policies (instead of PC5 security policies) in the Direct Communication Request message, as well as UE_1's security capabilities (the list of algorithms that UE_1 will accept for this connection). It should be noted that, in some scenarios, the security capability information of the UE_1 may not be sent by using the direct communication request. It may be understood that, in some scenarios, the UE_1 does not need to provide the security capability information to the UE_2, for example, the UE_2 pre-stores the security capability information of the UE_1, which is not limited herein.
Step a3: security policy comparison and rejection; if UE_1's RSPP security policy for integrity is “NOT NEEDED,” UE_2 shall reject the Direct Communication Request. UE_2 shall also reject the Direct Communication Request if UE_1's RSPP security policy for confidentiality is “NOTNEEDED” while UE_2's RSPP security policy for confidentiality is “REQUIRED.”UE_2 shall also reject the Direct Communication Request if UE_1's RSPP security policy for confidentiality is “REQUIRED” while UE_2's RSPP security policy for confidentiality is “NOT NEEDED.”UE_2 may initiate a Direct Authentication and Key Establishment procedure with UE_1.
Step a4: security policy comparison and acceptance; UE_2 accepts the Direct Communication Request if both UE_1's and UE_2′ RSPP security policies for confidentiality are “NOT NEEDED” or both UE_1's and UE_2′ RSPP security policies for confidentiality are “REQUIRED.” If UE_1's RSPP security policy for confidentiality is “NOTNEEDED” and UE_2′ RSPP security policy for confidentiality is “PREFERRED,” or UE_1's RSPP security policy for confidentiality is “PREFERRED” and UE_2′ RSPP security policy for confidentiality is “NOT NEEDED,” UE_2 also accepts the Direct Communication Request. Once having decided on the RSPP security policies to be used, UE_2 chooses the security algorithms for integrity and confidentiality based on the received UE_1's security capabilities and its own security capabilities.
Step a5: UE_2 sends back the chosen algorithms in the Direct Security Mode Command message. UE_1's RSPP security policies and UE_1's security capabilities are also returned to UE_1 to avoid bidding-down attack. This message is integrity protected with the algorithm chosen for integrity.
Step a6: unlike the UP (user plane) security policy negotiation defined for V2X security, UE_1 who initiated the Direct Communication Request for Ranging/Sidelink Positioning service shall not include in the Direct Security Mode Complete message any UP security policies which is not available in RSPP security policies. This message is protected by the selected algorithm.
Step a7: UE_2 sends the Direct Communication Accept message to the UE1.

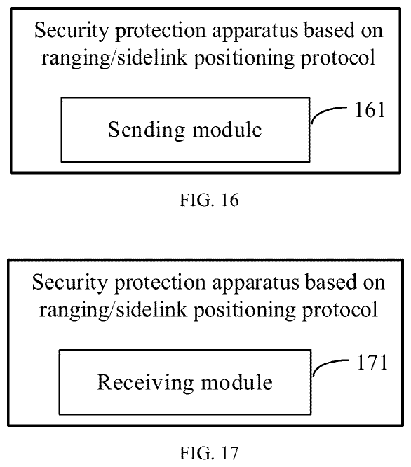

As shown in FIG. 16, an embodiment provides a security protection apparatus based on a ranging/sidelink positioning protocol, including:
a sending module 161, configured to send ranging/sidelink positioning protocol security policy information to a terminal;
wherein the ranging/sidelink positioning protocol security policy information indicates a security policy for the terminal to perform a ranging/sidelink positioning protocol procedure.

It should be noted that those skilled in the art may understand that the method provided in the embodiments of the present disclosure may be performed separately, or may be performed together with some methods in the embodiments of the present disclosure or some methods in related technologies.

As shown in FIG. 17, an embodiment provides a security protection apparatus based on a ranging/sidelink positioning protocol, including:
a receiving module 171, configured to receive ranging/sidelink positioning protocol security policy information sent by a network function;
wherein the ranging/sidelink positioning protocol security policy information indicates a security policy for the terminal to perform a ranging/sidelink positioning protocol procedure.

It should be noted that those skilled in the art may understand that the method provided in the embodiments of the present disclosure may be performed separately, or may be performed together with some methods in the embodiments of the present disclosure or some methods in related technologies.

An embodiment of the present disclosure provides a communication device, including:
a processor;
a memory, storing an instruction executable by the processor;
the processor is configured to execute the executable instruction to implement the method according to any embodiment of the present disclosure.

The memory may include various types of storage medium, the storage medium are non-transitory computer storage medium, and can continue to remember information stored thereon after the communication device is powered down.

The processor may be connected to the memory by using a bus or the like, and is configured to read the executable program stored in the memory.

An embodiment of the present disclosure provides a computer storage medium, storing a computer-executable program, wherein when the computer-executable program is executed by a processor, the method according to any embodiment of the present disclosure is implemented.

Regarding the apparatus in the above embodiments, the specific manner for each module to perform an operation has been described in detail in the method embodiments, and will not be repeated herein.

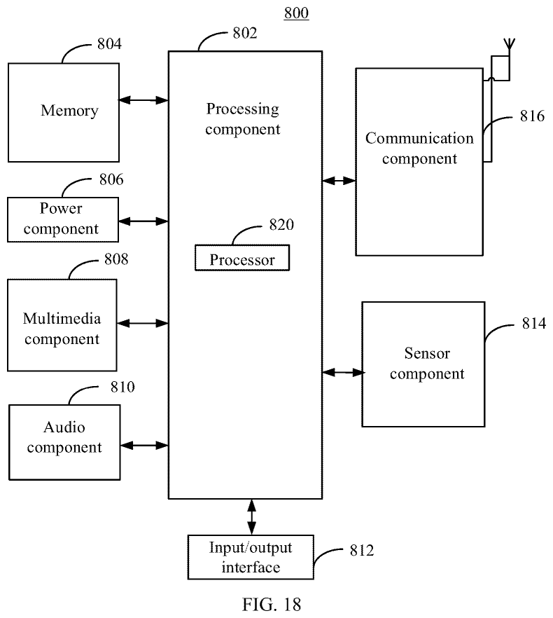

As shown in FIG. 18, an embodiment of the present disclosure provides a structure of a terminal.

Referring to a terminal 800 shown in FIG. 18, this embodiment provides the terminal 800, where the terminal may be specifically a mobile phone, a computer, a digital broadcast terminal, a messaging device, a game console, a tablet device, a medical device, fitness equipment, a personal digital assistant, or the like.

Referring to FIG. 18, the terminal 800 may include one or more of following components: a processing component 802, a memory 804, a power component 806, a multimedia component 808, an audio component 810, an input/output (I/O) interface 812, a sensor component 814, and a communication component 816.

The processing component 802 generally controls overall operations of the terminal 800, such as operations associated with display, telephone calls, data communications, camera operations, and recording operations. The processing component 802 may include one or more processors 820 to execute instructions to perform all or part of the steps of the method described above. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations on the terminal 800. Examples of such data include instructions for any application or method operating on the terminal 800, contact data, phonebook data, messages, pictures, videos, and the like. The memory 804 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disks.

The power component 806 provides power for various components of the terminal 800. The power component 806 may include a power management system, one or more power sources, and other components associated with generating, managing, and distributing power for the terminal 800.

The multimedia component 808 includes a screen providing an output interface between the terminal 800 and a user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensor may not only sense a boundary of a touch or slide action, but also detect a duration and pressure associated with the touch or slide operation. In some embodiments, the multimedia component 808 includes a front camera and/or a rear camera. When the terminal 800 is in an operation mode, such as a photographing mode or a video mode, the front camera and/or the rear camera may receive external multimedia data. Each of the front camera and the rear camera may be a fixed optical lens system or have focal length and optical zoom capability.

The audio component 810 is configured to output and/or input audio signals. For example, the audio component 810 includes a microphone (MIC) configured to receive an external audio signal when the terminal 800 is in an operation mode, such as a call mode, a recording mode, and a voice recognition mode. The received audio signal may be further stored in the memory 804 or transmitted via the communication component 816. In some embodiments, the audio component 810 further includes a speaker configured to output an audio signal.

The I/O interface 812 provides an interface between the processing component 802 and peripheral interface modules, such as keyboards, click wheels, buttons, etc. These buttons may include, but are not limited to, home buttons, volume buttons, start buttons, and lock buttons.

The sensor component 814 includes one or more sensors for providing status assessments of various aspects of the terminal 800. For example, the sensor component 814 may detect an open/closed state of the terminal 800, relative positioning of components (for example, a display and a keypad of the terminal 800), a position change of the terminal 800 or a component of the terminal 800, a presence or absence of user contact with the terminal 800, an orientation or acceleration/deceleration of the terminal 800, and a temperature change of the terminal 800. The sensor component 814 may include a proximity sensor configured to detect, without any physical contact, the presence of nearby objects. The sensor component 814 may also include a light sensor, such as a CMOS (Complementary Metal-Oxide-Semiconductor) or CCD (Charge Coupled Device) image sensor, for use in imaging applications. In some embodiments, the sensor component 814 may further include an acceleration sensor, a gyroscope sensor, a magnetic sensor, a pressure sensor, or a temperature sensor.

The communication component 816 is configured to facilitate wired or wireless communication between the terminal 800 and other devices. The terminal 800 may access a wireless network based on a communication standard, such as Wi-Fi, 2G, or 3G, or a combination thereof. In an example embodiment, the communication component 816 receives a broadcast signal or broadcast related information from an external broadcast management system via a broadcast channel. In an example embodiment, the communication component 816 further includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology, and other technologies.

In an example embodiment, the terminal 800 may be implemented by one or more application specific integrated circuit (ASIC), digital signal processor (DSPs), digital signal processing device (DSPD), programmable logic device (PLD), field programmable gate array (FPGA), controller, micro-controller, microprocessor, or other electronic component, and is configured to perform the above method.

In an example embodiment, a non-transitory computer-readable storage medium is further included, such as the memory 804 including an instruction, where the instruction can be executed by the processor 820 of the terminal 800, so as to perform the method described above. For example, the non-transitory computer-readable storage medium may be a ROM (read-only memory), a RAM (random access memory), CD-ROM (compact disc read-only memory), magnetic tape, floppy disk, optical data storage device, or the like.

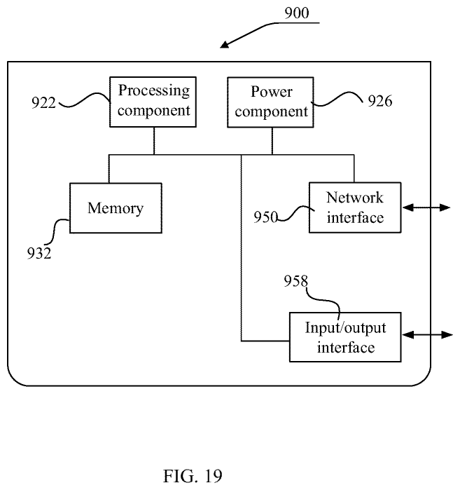

As shown in FIG. 19, an embodiment of the present disclosure provides a structure of a base station. For example, the base station 900 may be provided as a network-side device. Referring to FIG. 19, the base station 900 includes: a processing component 922, where the processing component 922 further includes one or more processors; and memory resources represented by a memory 932 for storing instructions executable by the processing component 922, such as an application program. The application program stored in the memory 932 may include one or more modules each corresponding to a set of instructions. In addition, the processing component 922 is configured to execute instructions to perform any of the above methods applied to the base station.

The base station 900 may also include a power component 926 configured to perform power management of the base station 900, a wired or wireless network interface 950 configured to connect the base station 900 to a network, and an input/output (I/O) interface 958. The base station 900 may operate based on an operating system stored in the memory 932, such as Windows Server™, Mac OS X™, Unix™, Linux™, FreeBSD™, or the like.

Other embodiments of the present disclosure will be readily apparent to those skilled in the art upon consideration of the specification and practice of the present disclosure herein. The present disclosure is intended to cover any variations, uses, or adaptations of the present disclosure that follow the general principles of the present disclosure and include common knowledge or conventional technical means in the art not disclosed in the present disclosure. The specification and embodiments are to be regarded as examples only, and the true scope and spirit of the present disclosure are indicated by the following claims.

It should be understood that the present disclosure is not limited to the precise structure already described above and shown in the drawings, and that various modifications and changes may be made without departing from the scope thereof. The scope of the present disclosure is limited only by the appended claims.

1. A method of security protection based on a ranging/sidelink positioning protocol, performed by a network function, the method comprising:
sending ranging/sidelink positioning protocol security policy information to a terminal;
wherein the ranging/sidelink positioning protocol security policy information indicates a security policy for the terminal to perform a ranging/sidelink positioning protocol procedure.

2. The method according to claim 1, wherein the ranging/sidelink positioning protocol security policy information indicates a mapping relation between at least one ranging/sidelink positioning service and a corresponding ranging/sidelink positioning protocol security policy.

3. The method according to claim 1, wherein the ranging/sidelink positioning protocol security policy information comprises at least one of:
signaling integrity protection information, indicating a following ranging/sidelink positioning protocol policy:
the terminal accepts a connection in a case that a PC5 interface is under integrity protection;
signaling confidentiality protection information, indicating one of following ranging/sidelink positioning protocol policies:
the terminal accepts a connection in a case that a PC5 interface is under confidentiality protection;
the terminal establishes a connection without confidentiality protection;
the terminal tries to establish confidentiality protection and accepts a connection without confidentiality protection.

4. The method according to claim 1, wherein the network function is a policy control function (PCF), and sending the ranging/sidelink positioning protocol security policy information to the terminal comprises:
sending the ranging/sidelink positioning protocol security policy information to the terminal during a service authorization and configuration procedure.

5. The method according to claim 1, wherein the network function is a 5G proximity service key management function (PKMF) or a 5G proximity service direct discovery name management function (DDNMF), and
sending the ranging/sidelink positioning protocol security policy information to the terminal comprises:
sending the ranging/sidelink positioning protocol security policy information to the terminal during a terminal discovery procedure.

6. A method of security protection based on a ranging/sidelink positioning protocol, performed by a terminal, the method comprising:
receiving ranging/sidelink positioning protocol security policy information sent by a network function;
wherein the ranging/sidelink positioning protocol security policy information indicates a security policy for the terminal to perform a ranging/sidelink positioning protocol procedure.

7. The method according to claim 6, wherein the ranging/sidelink positioning protocol security policy information indicates a mapping relation between at least one ranging/sidelink positioning service and a corresponding ranging/sidelink positioning protocol security policy.

8. The method according to claim 6, wherein the ranging/sidelink positioning protocol security policy information comprises at least one of:
signaling integrity protection information, indicating a following ranging/sidelink positioning protocol policy:
the terminal accepts a connection in a case that a PC5 interface is under integrity protection;
signaling confidentiality protection information, indicating one of following ranging/sidelink positioning protocol policies:
the terminal accepts a connection in a case that a PC5 interface is under confidentiality protection;
the terminal establishes a connection without confidentiality protection;
the terminal tries to establish confidentiality protection and accepts a connection without confidentiality protection.

9. The method according to claim 6, wherein the network function is a policy control function (PCF), and
receiving the ranging/sidelink positioning protocol security policy information sent by the network function comprises:
receiving the ranging/sidelink positioning protocol security policy information sent by the network function during a service authorization and configuration procedure.

10. The method according to claim 6, wherein the network function is a 5G proximity service key management function (PKMF) or a 5G proximity service direct discovery name management function (DDNMF), and receiving the ranging/sidelink positioning protocol security policy information sent by the network function comprises:
receiving the ranging/sidelink positioning protocol security policy information sent by the network function during a terminal discovery procedure.

11. The method according to claim 6, wherein the terminal is a first terminal initiating direct communication; and the method further comprises:
determining, by the first terminal, a second terminal, and determining that the direct communication is established for a ranging/sidelink positioning service rather than for a proximity service (ProSe).

12. The method according to claim 11, further comprising:
choosing a ranging/sidelink positioning protocol security policy of the first terminal to be sent to the second terminal based on the ranging/sidelink positioning protocol security policy information;
sending the ranging/sidelink positioning protocol security policy of the first terminal, or security capability information of the first terminal, or both, to the second terminal;
wherein sending the ranging/sidelink positioning protocol security policy of the first terminal, or the security capability information of the first terminal, or both, to the second terminal comprises:
sending the ranging/sidelink positioning protocol security policy of the first terminal, or the security capability information of the first terminal, or both, to the second terminal through a direct communication request message;
wherein the method further comprises:
receiving at least one of: information of a security algorithm, the ranging/sidelink positioning protocol security policy of the first terminal, or the security capability information of the terminal sent by the second terminal;
wherein receiving at least one of: the information of the security algorithm, the ranging/sidelink positioning protocol security policy of the first terminal, or the security capability information of the first terminal sent by the second terminal comprises:
receiving, through a direct security mode command message, at least one of: the information of the security algorithm, the ranging/sidelink positioning protocol security policy of the first terminal, or the security capability information of the first terminal sent by the second terminal.

13.-16. (canceled)

17. The method according to claim 6, wherein the terminal is a discovered second terminal for direct communication; and the method further comprises:
receiving a ranging/sidelink positioning protocol security policy of a first terminal, or security capability information of the first terminal, or both, sent by the first terminal initiating the direction communication.

18. The method according to claim 17, wherein receiving the ranging/sidelink positioning protocol security policy of the first terminal, or the security capability information of the first terminal, or both, sent by the first terminal initiating the direction communication comprises:
receiving, through a direct communication request message, the ranging/sidelink positioning protocol security policy of the first terminal, or the security capability information of the first terminal, or both, sent by the first terminal.

19. The method according to claim 18, further comprising at least one of:
rejecting the direct communication request message, wherein the ranging/sidelink positioning protocol security policy of the first terminal indicates that the terminal establishes a connection without integrity protection;
rejecting the direct communication request message, wherein the ranging/sidelink positioning protocol security policy of the first terminal indicates that the terminal establishes a connection without confidentiality protection, and a ranging/sidelink positioning protocol security policy of the second terminal indicates that the terminal accepts a connection in a case that a PC5 interface is under confidentiality protection; or
rejecting the direct communication request message, in response to determining wherein the ranging/sidelink positioning protocol security policy of the first terminal indicates that the terminal accepts a connection in a case that a PC5 interface is under confidentiality protection, and a ranging/sidelink positioning protocol security policy of the second terminal indicates that the terminal establishes a connection without confidentiality protection; or
wherein the method further comprises at least one of:
accepting the direct communication request message, wherein both the ranging/sidelink positioning protocol security policy of the first terminal and a ranging/sidelink positioning protocol security policy of the second terminal indicate that the terminal establishes a connection without confidentiality protection;
accepting the direct communication request message, wherein both the ranging/sidelink positioning protocol security policy of the first terminal and the ranging/sidelink positioning protocol security policy of the second terminal indicate that the terminal accepts a connection in a case that a PC5 interface is under confidentiality protection;
accepting the direct communication request message, wherein the ranging/sidelink positioning protocol security policy of the first terminal indicates that the terminal establishes a connection without confidentiality protection, and the ranging/sidelink positioning protocol security policy of the second terminal indicates that the terminal tries to establish confidentiality protection and accepts a connection without confidentiality protection;
accepting the direct communication request message, wherein the ranging/sidelink positioning protocol security policy of the first terminal indicates that the terminal tries to establish confidentiality protection and accepts a connection without confidentiality protection, and the ranging/sidelink positioning protocol security policy of the second terminal indicates that the terminal establishes a connection without confidentiality protection;
accepting the direct communication request message, wherein the ranging/sidelink positioning protocol security policy of the first terminal indicates that the terminal accepts a connection in a case that a PC5 interface is under confidentiality protection, and the ranging/sidelink positioning protocol security policy of the second terminal indicates that the terminal tries to establish confidentiality protection and accepts a connection without confidentiality protection; or
accepting the direct communication request message, wherein the ranging/sidelink positioning protocol security policy of the first terminal indicates that the terminal tries to establish confidentiality protection and accepts a connection without confidentiality protection, and the ranging/sidelink positioning protocol security policy of the second terminal indicates that the terminal accepts a connection in a case that a PC5 interface is under confidentiality protection.

20. (canceled)

21. The method according to claim 17, further comprising:
determining to adopt the ranging/sidelink positioning protocol security policy, determining a security algorithm for integrity protection, or confidentiality protection, or both, based on the security capability information of the first terminal and security capability information of the second terminal;
sending at least one of: information of the security algorithm, the ranging/sidelink positioning protocol security policy of the first terminal, or the security capability information of the first terminal to the first terminal;
wherein sending at least one of: the information of the security algorithm, the ranging/sidelink positioning protocol security policy of the first terminal, or the security capability information of the first terminal to the first terminal comprises:
sending at least one of: the information of the security algorithm, the ranging/sidelink positioning protocol security policy of the first terminal, or the security capability information of the first terminal to the first terminal through a direct security mode command message;
wherein the direct security mode command message is integrity protected with the security algorithm chosen for integrity protection.

22.-26. (canceled)

27. A communication device, comprising:
a memory;
a processor, connected to the memory,
wherein an executable instruction stored on the memory, when executed by the processor, cause the communication device to perform the method according to claim 1.

28. A non-transitory computer storage medium, storing a computer-executable instruction, wherein the computer-executable instruction, when executed by a processor, causes the processor to perform the method according to claim 1.

29. A communication device, comprising:
a memory;
a processor, connected to the memory, and configured to execute a computer-executable instruction stored on the memory to:
receive ranging/sidelink positioning protocol security policy information sent by a network function;
wherein the ranging/sidelink positioning protocol security policy information indicates a security policy for the communication device to perform a ranging/sidelink positioning protocol procedure.

30. A non-transitory computer storage medium, storing a computer-executable instruction, wherein the computer-executable instruction, when executed by a processor, causes the processor to perform the method according to claim 6.
